(19) United States
(12) Patent Application Publication
(10) Pub. No.: US 2024/0264770 A1
(43) Pub. Date: Aug. 8, 2024

(54) TECHNIQUES FOR TAGGING DATA BASED ON CHUNK SIZE

(71) Applicant: Micron Technology, Inc., Boise, ID (US)

(72) Inventor: Yanhua Bi, Shanghai (CN)

(21) Appl. No.: 18/423,157

(22) Filed: Jan. 25, 2024

Related U.S. Application Data
(60) Provisional application No. 63/444,179, filed on Feb. 8, 2023.

(51) Int. Cl. G06F 3/06

(52) U.S. Cl. CPC G06F 3/0659; G06F 3/0604; G06F 3/0656; G06F 3/0679

(57) ABSTRACT

Methods, systems, and devices for techniques for tagging data based on chunk size are described. Generally, the described techniques provide for a device tagging data according to a chunk size of the data. The device may receive a command to write data. The command may include a first indication of a first type of the data (e.g., hot data, cold data). The device may determine whether a size of the data satisfies a threshold based on the command. The device may generate a second indication of a second type of the data based on whether the size of the data satisfies the threshold. The device may write the data to a buffer including a first set of blocks for storing the data in a first type of memory cells based on the second indication of the second type of the data (e.g., hot data, cold data).

### CROSS REFERENCE

The present Application for Patent claims priority to U.S. Patent Application No. 63/444,179 by Yanhua Bi, entitled “TECHNIQUES FOR TAGGING DATA BASED ON CHUNK SIZE,” filed Feb. 8, 2023, which is assigned to the assignee hereof, and which is expressly incorporated by reference in its entirety herein.

### TECHNICAL FIELD

The following relates to one or more systems for memory, including techniques for tagging data based on chunk size.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 illustrates an example of a system that supports techniques for tagging data based on chunk size in accordance with examples as disclosed herein.

FIG. 2 illustrates an example of a memory die that supports techniques for tagging data based on chunk size in accordance with examples as disclosed herein.

FIGS. 3A and 3B illustrate examples of data structures that support techniques for tagging data based on chunk size in accordance with examples as disclosed herein.

FIG. 4 illustrates an example of a process flow that supports techniques for tagging data based on chunk size in accordance with examples as disclosed herein.

FIG. 5 illustrates a block diagram of a memory device that supports techniques for tagging data based on chunk size in accordance with examples as disclosed herein.

FIG. 6 illustrates a flowchart showing a method or methods that support techniques for tagging data based on chunk size in accordance with examples as disclosed herein.

### DETAILED DESCRIPTION

Memory systems may be provided in accordance with various configurations which support tagging (e.g., classifying, assigning, identifying) of data into one or more types. In some cases, a memory system may operate as a flash memory management system (e.g., a flash-friendly file system (F2FS)). The flash memory management system may classify data by associating the data with information, such as a group identifier (ID) or a data tag. In some cases, the flash memory management system may tag data according to a file extension associated with the data, a lifetime of the data, or both. For instance, data having a file extension, such as .avi, .exe, .gif, or .mp4, among other examples, may be tagged as cold data, while data having another file extension, such as .db, for example, may be tagged as hot data. Data that has been stored within the memory system for a longer duration may be tagged as cold data, while data that has been stored within the memory system for a shorter duration (e.g., compared to the cold data) may be tagged as hot data. Such classifications may correspond to an access frequency associated with the data (e.g., cold data may be accessed relatively infrequently and hot data may be accessed relatively frequently). However, data tagging by the flash memory management system may result instances of a memory device accessing cold data relatively frequently, which may degrade or limit performance of the memory system.

Various aspects of the present disclosure relate to data tagging at the memory system according to a chunk size of the data. For example, upon receiving an access command (e.g., a read command or a write command), the memory system may identify the chunk size of the data and may compare the chunk size to one or more thresholds. A chunk size of data may be a size of the data, for example, in units of kilobyte (KB), megabyte (MB), and gigabyte (GB), etc. In some examples, a chunk size of data may be 32 KB. In some other examples, a chunk size of data may be 512 KB. In other examples, a chunk size of data may be 4 KB. Other examples of chunk size may be supported and is not limited to any of the above examples. In some cases, the memory system may determine the chunk size to be greater than a first threshold (e.g., an update data threshold) and less than a second threshold (e.g., a chunk size threshold), and may classify the data as hot data. In some cases, the memory system may determine the chunk size to be greater than the second threshold, and may classify the data as cold data. By classifying data based on a size of the data, the memory system may experience improvements to data storage and data retrieval associated with performing access operations.

In addition to applicability in memory systems as described herein, techniques for improved techniques for tagging data based on chunk size may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by facilitating the tagging of data based on one or more factors, such as chunk size, which may improve data storage and/or data retrieval, among other benefits.

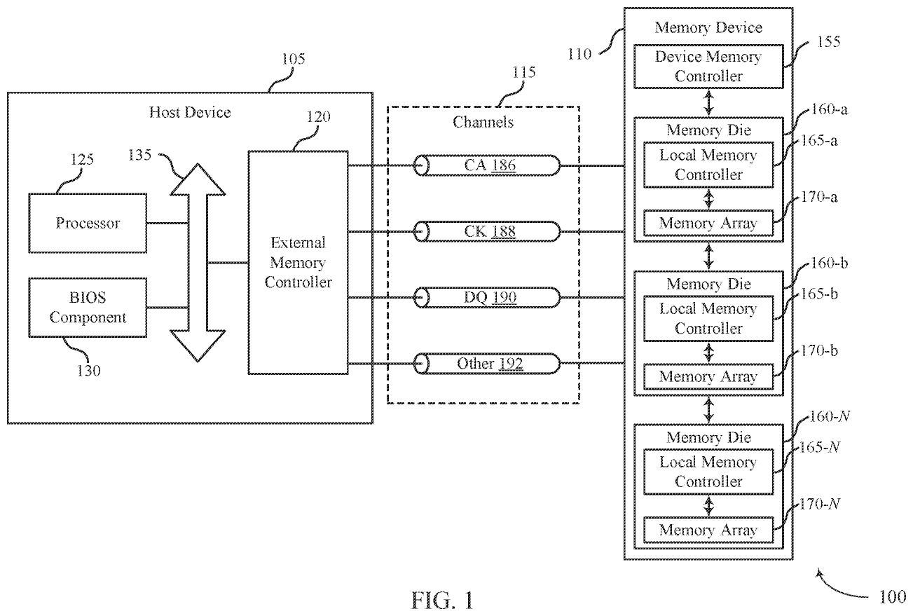

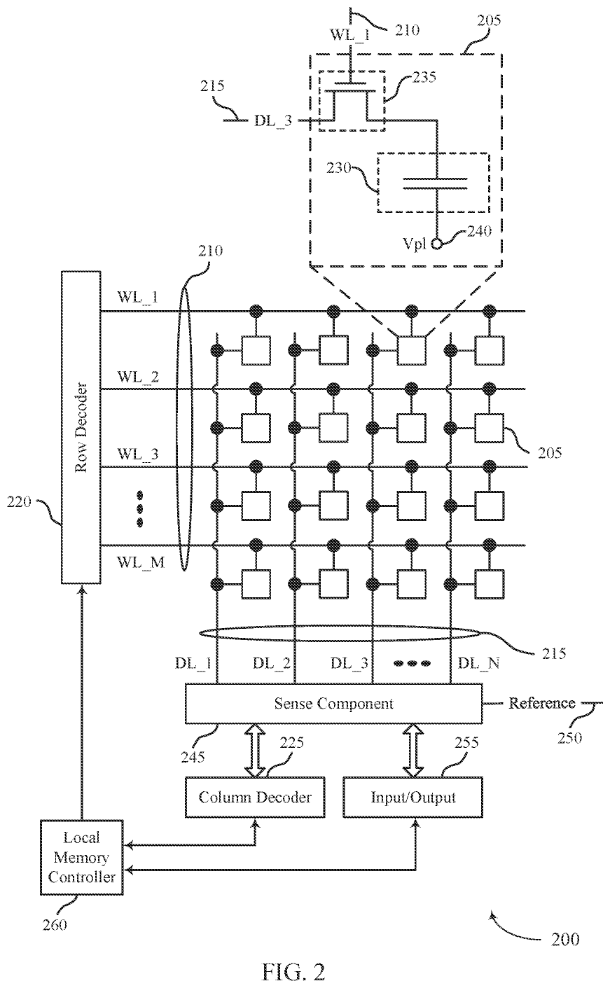

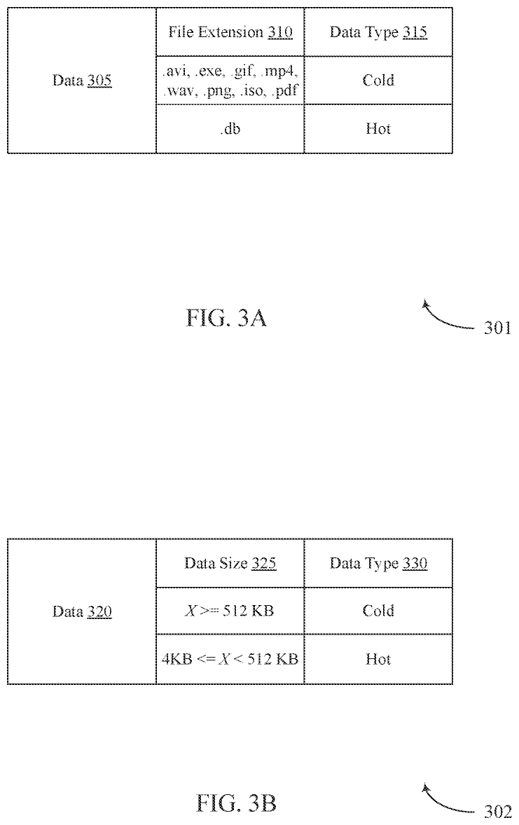

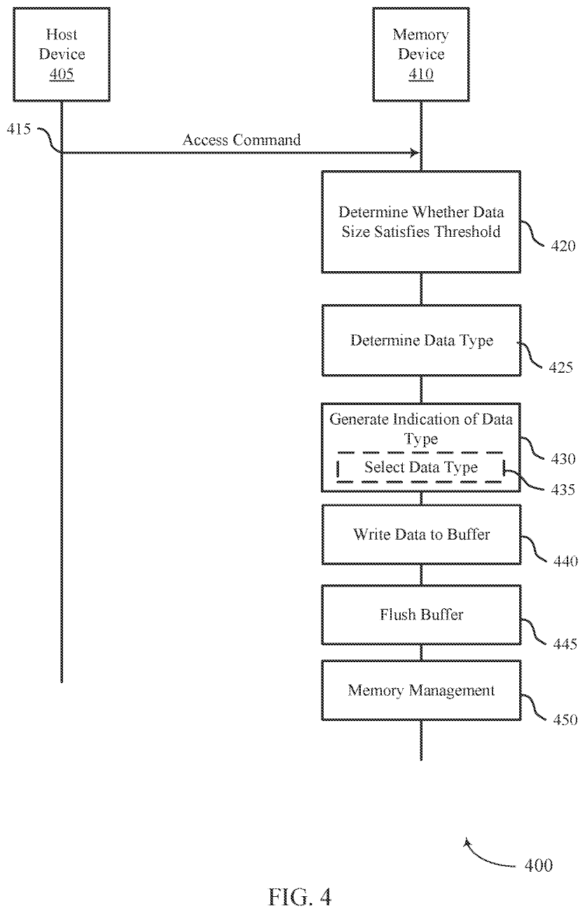

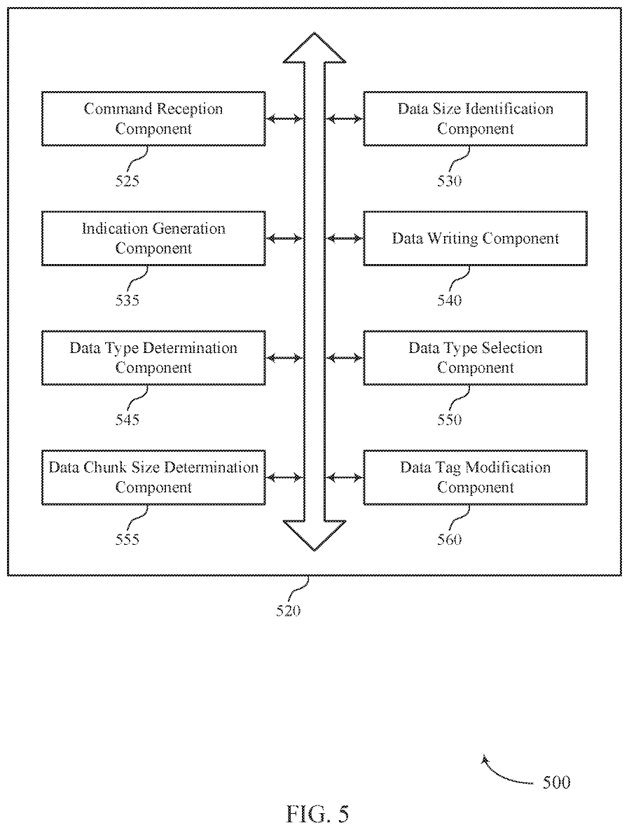

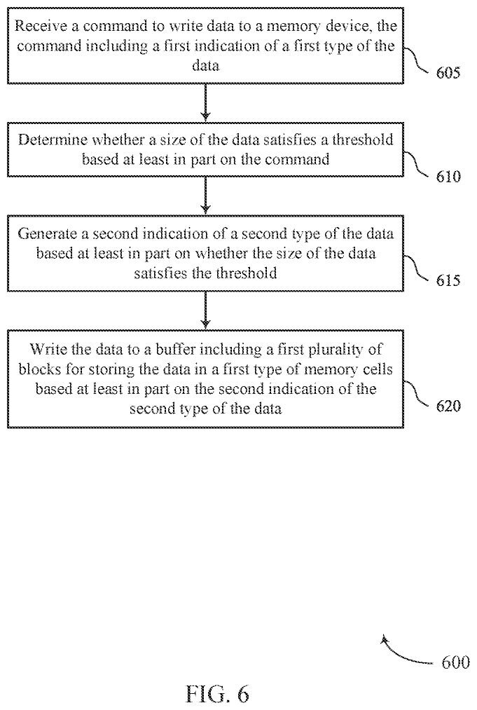

Features of the disclosure are initially described in the context of systems and dies as described with reference to FIGS. 1 and 2. Features of the disclosure are described in the context data structures and process flows as described with reference to FIGS. 3A through 4. These and other features of the disclosure are further illustrated by and described with reference to an apparatus diagram and flowcharts that relate to techniques for tagging data based on chunk size as described with reference to FIGS. 5 and 6.

FIG. 1 illustrates an example of a system 100 that supports techniques for tagging data based on chunk size in accordance with examples as disclosed herein. The system 100 may include a host device 105, a memory device 110, and a plurality of channels 115 coupling the host device 105 with the memory device 110. The system 100 may include one or more memory devices 110, but aspects of the one or more memory devices 110 may be described in the context of a single memory device (e.g., memory device 110).

The system 100 may include portions of an electronic device, such as a computing device, a mobile computing device, a wireless device, a graphics processing device, a vehicle, or other systems. For example, the system 100 may illustrate aspects of a computer, a laptop computer, a tablet computer, a smartphone, a cellular phone, a wearable device, an internet-connected device, a vehicle controller, or the like. The memory device 110 may be a component of the system 100 that is operable to store data for one or more other components of the system 100.

Portions of the system 100 may be examples of the host device 105. The host device 105 may be an example of a processor (e.g., circuitry, processing circuitry, a processing component) within a device that uses memory to execute processes, such as within a computing device, a mobile computing device, a wireless device, a graphics processing device, a computer, a laptop computer, a tablet computer, a smartphone, a cellular phone, a wearable device, an internet-connected device, a vehicle controller, a system on a chip (SoC), or some other stationary or portable electronic device, among other examples. In some examples, the host device 105 may refer to the hardware, firmware, software, or any combination thereof that implements the functions of an external memory controller 120. In some examples, the external memory controller 120 may be referred to as a host (e.g., host device 105).

A memory device 110 may be an independent device or a component that is operable to provide physical memory addresses/space that may be used or referenced by the system 100. In some examples, a memory device 110 may be configurable to work with one or more different types of host devices. Signaling between the host device 105 and the memory device 110 may be operable to support one or more of: modulation schemes to modulate the signals, various pin configurations for communicating the signals, various form factors for physical packaging of the host device 105 and the memory device 110, clock signaling and synchronization between the host device 105 and the memory device 110, timing conventions, or other functions.

The memory device 110 may be operable to store data for the components of the host device 105. In some examples, the memory device 110 (e.g., operating as a secondary-type device to the host device 105, operating as a dependent-type device to the host device 105) may respond to and execute commands provided by the host device 105 through the external memory controller 120. Such commands may include one or more of a write command for a write operation, a read command for a read operation, a refresh command for a refresh operation, or other commands.

The host device 105 may include one or more of one or more external memory controllers 120, one or more processors 125, a basic input/output system (BIOS) component 130, or other components such as one or more peripheral components or one or more input/output controllers. The components of the host device 105 may be coupled with one another using a bus 135.

The processor 125 may be operable to provide functionality (e.g., control functionality) for the system 100 or the host device 105. The processor 125 may be a general-purpose processor, a digital signal processor (DSP), an application-specific integrated circuit (ASIC), a field-programmable gate array (FPGA) or other programmable logic device, discrete gate or transistor logic, discrete hardware components, or any combination of these components. In such examples, the processor 125 may be an example of a central processing unit (CPU), a graphics processing unit (GPU), a general purpose GPU (GPGPU), or an SoC, among other examples. In some examples, the external memory controller 120 may be implemented by or be a part of the processor 125.

The BIOS component 130 may be a software component that includes a BIOS operated as firmware, which may initialize and run various hardware components of the system 100 or the host device 105. The BIOS component 130 may also manage data flow between the processor 125 and the various components of the system 100 or the host device 105. The BIOS component 130 may include instructions (e.g., a program, software) stored in one or more of read-only memory (ROM), flash memory, or other non-volatile memory.

The memory device 110 may include one or more device memory controllers 155 and one or more memory dies 160 (e.g., memory chips) to support a capacity (e.g., a desired capacity, a specified capacity) for data storage. Each memory die 160 (e.g., memory die 160-a, memory die 160-b, memory die 160-N) may include one or more local memory controllers 165 (e.g., local memory controller 165-a, local memory controller 165-b, local memory controller 165-N) and one or more memory arrays 170 (e.g., memory array 170-a, memory array 170-b, memory array 170-N). A memory array 170 may be a collection (e.g., one or more grids, one or more banks, one or more tiles, one or more sections) of memory cells, with each memory cell being operable to store one or more bits of data. A memory device 110 including two or more memory dies 160 may be referred to as a multi-die memory or a multi-die package or a multi-chip memory or a multi-chip package.

The device memory controller 155 may include components (e.g., circuitry, logic) operable to control operation of the memory device 110. The device memory controller 155 may include hardware, firmware, or instructions that enable the memory device 110 to perform various operations and may be operable to receive, transmit, or execute commands, data, or control information related to the components of the memory device 110. The device memory controller 155 may be operable to communicate with one or more of the external memory controller 120, the one or more memory dies 160, or the processor 125. In some examples, the device memory controller 155 may control operation of the memory device 110 described herein in conjunction with the local memory controller 165 of the memory die 160.

In some examples, the memory device 110 may communicate information (e.g., data, commands, or both) with the host device 105. For example, the memory device 110 may receive a write command indicating that the memory device 110 is to store data received from the host device 105, or receive a read command indicating that the memory device 110 is to provide data stored in a memory die 160 to the host device 105, among other types of information communication.

A local memory controller 165 (e.g., local to a memory die 160) may include components (e.g., circuitry, logic) operable to control operation of the memory die 160. In some examples, a local memory controller 165 may be operable to communicate (e.g., receive or transmit data or commands or both) with the device memory controller 155. In some examples, a memory device 110 may not include a device memory controller 155, and a local memory controller 165 or the external memory controller 120 may perform various functions described herein. As such, a local memory controller 165 may be operable to communicate with the device memory controller 155, with other local memory controllers 165, or directly with the external memory controller 120, or the processor 125, or any combination thereof. Examples of components that may be included in the device memory controller 155 or the local memory controllers 165 or both may include receivers for receiving signals (e.g., from the external memory controller 120), transmitters for transmitting signals (e.g., to the external memory controller 120), decoders for decoding or demodulating received signals, encoders for encoding or modulating signals to be transmitted, or various other components operable for supporting described operations of the device memory controller 155 or local memory controller 165 or both.

The external memory controller 120 may be operable to enable communication of information (e.g., data, commands, or both) between components of the system 100 (e.g., between components of the host device 105, such as the processor 125, and the memory device 110). The external memory controller 120 may process (e.g., convert, translate) communications exchanged between the components of the host device 105 and the memory device 110. In some examples, the external memory controller 120, or other component of the system 100 or the host device 105, or its functions described herein, may be implemented by the processor 125. For example, the external memory controller 120 may be hardware, firmware, or software, or some combination thereof implemented by the processor 125 or other component of the system 100 or the host device 105. Although the external memory controller 120 is depicted as being external to the memory device 110, in some examples, the external memory controller 120, or its functions described herein, may be implemented by one or more components of a memory device 110 (e.g., a device memory controller 155, a local memory controller 165) or vice versa.

The components of the host device 105 may exchange information with the memory device 110 using one or more channels 115. The channels 115 may be operable to support communications between the external memory controller 120 and the memory device 110. Each channel 115 may be an example of a transmission medium that carries information between the host device 105 and the memory device 110. Each channel 115 may include one or more signal paths (e.g., a transmission medium, a conductor) between terminals associated with the components of the system 100. A signal path may be an example of a conductive path operable to carry a signal. For example, a channel 115 may be associated with a first terminal (e.g., including one or more pins, including one or more pads) at the host device 105 and a second terminal at the memory device 110. A terminal may be an example of a conductive input or output point of a device of the system 100, and a terminal may be operable to act as part of a channel.

Channels 115 (and associated signal paths and terminals) may be dedicated to communicating one or more types of information. For example, the channels 115 may include one or more command and address (CA) channels 186, one or more clock signal (CK) channels 188, one or more data (DQ) channels 190, one or more other channels 192, or any combination thereof. In some examples, signaling may be communicated over the channels 115 using single data rate (SDR) signaling or double data rate (DDR) signaling. In SDR signaling, one modulation symbol (e.g., signal level) of a signal may be registered for each clock cycle (e.g., on a rising or falling edge of a clock signal). In DDR signaling, two modulation symbols (e.g., signal levels) of a signal may be registered for each clock cycle (e.g., on both a rising edge and a falling edge of a clock signal).

The system 100 may include any quantity of non-transitory computer readable media that support tagging data based on chunk size. For example, the host device 105, the controller 120 and/or 155, a memory device 110, or a memory die 160 may include or otherwise may access one or more non-transitory computer readable media storing instructions (e.g., firmware) for performing the functions ascribed herein to the host device 105, the controller 120 and/or 155, memory device 110, or memory die 160. For example, such instructions, if executed by the host device 105 (e.g., by the external memory controller 120 and/or processor 125), by the controller 120 and/or 155, by a memory device 110 (e.g., by a device memory controller 155), or by a memory die 160 (e.g., by a local memory controller 165), may cause the host device 105, the controller 120 and/or 155, memory device 110, or memory device 140 to alone or in any combination perform associated functions as described herein.

In some cases, a memory device 110 may assign data with a data type based on one or more parameters associated with the data. For example, the data may be tagged according to a file extension associated with the data, according to a lifetime of the data, or both. For example, data having a relatively long lifetime may be tagged as cold data (e.g., data accessed relatively infrequently) and data having a relatively short lifetime may be tagged as hot data (e.g., data accessed relatively frequently). Similarly, various file extensions may indicate a data type associated with the stored data (e.g., a file extension of .exe may be associated with cold data and a file extension of .db may be associated with hot data). Such classification techniques, however, may result in instances of cold data being accessed relatively frequently. In some cases, the frequency which cold data is accessed may be correlated with a frequency of memory management operations performed by the memory system (e.g., garbage collection, fragmentation, or the like), which may incur adverse effects, such as write amplification.

To support data type tagging of data stored to a memory system (e.g., the system 100), a memory device 110 may tag data based on a chunk size of the data. A chunk size of data may be a size of the data, for example, in units of KB, MB, and GB, etc. The memory device 110 may receive a command from a host device 105 to perform an access operation on one or more memory cells of the memory device 110. As part of such an access operation, the host device 105 may further indicate a type associated with the accessed data (e.g., assigned a tag by an F2FS system or a similar system). The memory device 110 may compare a chunk size of the data to a threshold size in order to determine an updated tag for the data. For example, if the chunk size is greater than a first threshold size (e.g., 512 KB), the memory device 110 may tag the data chunk as cold data, and if the chunk size is greater than a second threshold size (e.g., 4 KB) but less than the first threshold size, the memory device 110 may tag the data chunk as hot data. By enabling data tagging according to a chunk size of data, the memory system may experience improvements to the performance of access operations.

FIG. 2 illustrates an example of a memory die 200 that supports techniques for tagging data based on chunk size in accordance with examples as disclosed herein. The memory die 200 may be an example of the memory dies 160 described with reference to FIG. 1. In some examples, the memory die 200 may be referred to as a memory chip, a memory device, or an electronic memory apparatus. The memory die 200 may include one or more memory cells 205 that may be programmable to store different logic states (e.g., programmed to one of a set of two or more possible states). For example, a memory cell 205 may be operable to store one bit of information at a time (e.g., a logic 0 or a logic 1). In some examples, a memory cell 205 (e.g., a multi-level memory cell) may be operable to store more than one bit of information at a time (e.g., a logic 00, logic 01, logic 10, a logic 11). In some examples, the memory cells 205 may be arranged in an array, such as a memory array 170 described with reference to FIG. 1.

In some examples, a memory cell 205 may store a charge representative of the programmable states in a capacitor. DRAM architectures may include a capacitor that includes a dielectric material to store a charge representative of the programmable state. In other memory architectures, other storage devices and components are possible. For example, nonlinear dielectric materials may be employed. The memory cell 205 may include a logic storage component, such as capacitor 230, and a switching component 235 (e.g., a cell selection component). The capacitor 230 may be an example of a dielectric capacitor or a ferroelectric capacitor. A node of the capacitor 230 may be coupled with a voltage source 240, which may be the cell plate reference voltage, such as Vp1, or may be ground, such as Vss.

The memory die 200 may include access lines (e.g., word lines 210, digit lines 215) arranged in a pattern, such as a grid-like pattern. An access line may be a conductive line coupled with a memory cell 205 and may be used to perform access operations on the memory cell 205. In some examples, word lines 210 may be referred to as row lines. In some examples, digit lines 215 may be referred to as column lines or bit lines. References to access lines, row lines, column lines, word lines, digit lines, or bit lines, or their analogues, are interchangeable without loss of understanding. Memory cells 205 may be positioned at intersections of the word lines 210 and the digit lines 215.

Operations such as reading and writing may be performed on the memory cells 205 by activating access lines such as a word line 210 or a digit line 215. By biasing a word line 210 and a digit line 215 (e.g., applying a voltage to the word line 210 or the digit line 215), a single memory cell 205 may be accessed at their intersection. The intersection of a word line 210 and a digit line 215 in a two-dimensional or in a three-dimensional configuration may be referred to as an address of a memory cell 205. Activating a word line 210 or a digit line 215 may include applying a voltage to the respective line.

Accessing the memory cells 205 may be controlled through a row decoder 220, or a column decoder 225, or any combination thereof. For example, a row decoder 220 may receive a row address from the local memory controller 260 and activate a word line 210 based on the received row address. A column decoder 225 may receive a column address from the local memory controller 260 and may activate a digit line 215 based on the received column address.

Selecting or deselecting the memory cell 205 may be accomplished by activating or deactivating the switching component 235 using a word line 210. The capacitor 230 may be coupled with the digit line 215 using the switching component 235. For example, the capacitor 230 may be isolated from digit line 215 when the switching component 235 is deactivated, and the capacitor 230 may be coupled with digit line 215 when the switching component 235 is activated.

The sense component 245 may be operable to detect a state (e.g., a charge) stored on the capacitor 230 of the memory cell 205 and determine a logic state of the memory cell 205 based on the stored state. The sense component 245 may include one or more sense amplifiers to amplify or otherwise convert a signal resulting from accessing the memory cell 205. The sense component 245 may compare a signal detected from the memory cell 205 to a reference 250 (e.g., a reference voltage). The detected logic state of the memory cell 205 may be provided as an output of the sense component 245 (e.g., to an input/output 255), and may indicate the detected logic state to another component of a memory device (e.g., a memory device 110) that includes the memory die 200.

The local memory controller 260 may control the accessing of memory cells 205 through the various components (e.g., row decoder 220, column decoder 225, sense component 245). The local memory controller 260 may be an example of the local memory controller 165 described with reference to FIG. 1. In some examples, one or more of the row decoder 220, column decoder 225, and sense component 245 may be co-located with the local memory controller 260. The local memory controller 260 may be operable to receive one or more of commands or data from one or more different memory controllers (e.g., an external memory controller 120 associated with a host device 105, another controller associated with the memory die 200), translate the commands or the data (or both) into information that can be used by the memory die 200, perform one or more operations on the memory die 200, and communicate data from the memory die 200 to a host (e.g., a host device 105) based on performing the one or more operations. The local memory controller 260 may generate row signals and column address signals to activate the target word line 210 and the target digit line 215. The local memory controller 260 also may generate and control various signals (e.g., voltages, currents) used during the operation of the memory die 200. In general, the amplitude, the shape, or the duration of an applied voltage or current discussed herein may be varied and may be different for the various operations discussed in operating the memory die 200.

The local memory controller 260 may be operable to perform one or more access operations on one or more memory cells 205 of the memory die 200. Examples of access operations may include a write operation, a read operation, a refresh operation, a precharge operation, or an activate operation, among others. In some examples, access operations may be performed by or otherwise coordinated by the local memory controller 260 in response to various access commands (e.g., from a host device 105). The local memory controller 260 may be operable to perform other access operations not listed here or other operations related to the operating of the memory die 200 that are not directly related to accessing the memory cells 205.

The local memory controller 260 may be operable to perform a write operation (e.g., a programming operation) on one or more memory cells 205 of the memory die 200. During a write operation, a memory cell 205 of the memory die 200 may be programmed to store a desired state (e.g., logic state, charge state). The local memory controller 260 may identify a target memory cell 205 on which to perform the write operation. The local memory controller 260 may identify a target word line 210 and a target digit line 215 coupled with the target memory cell 205 (e.g., an address of the target memory cell 205). The local memory controller 260 may activate the target word line 210 and the target digit line 215 (e.g., applying a voltage to the word line 210 or digit line 215) to access the target memory cell 205. The local memory controller 260 may apply a signal (e.g., a write pulse, a write voltage) to the digit line 215 during the write operation to store a specific state (e.g., charge) in the capacitor 230 of the memory cell 205. The signal used as part of the write operation may include one or more voltage levels over a duration.

The local memory controller 260 may be operable to perform a read operation (e.g., a sense operation) on one or more memory cells 205 of the memory die 200. During a read operation, the state (e.g., logic state, charge state) stored in a memory cell 205 of the memory die 200 may be evaluated (e.g., read, determined, identified). The local memory controller 260 may identify a target memory cell 205 on which to perform the read operation. The local memory controller 260 may identify a target word line 210 and a target digit line 215 coupled with the target memory cell 205 (e.g., the address of the target memory cell 205). The local memory controller 260 may activate the target word line 210 and the target digit line 215 (e.g., applying a voltage to the word line 210 or digit line 215) to access the target memory cell 205. The target memory cell 205 may transfer a signal (e.g., charge, voltage) to the sense component 245 in response to biasing the access lines. The sense component 245 may amplify the signal. The local memory controller 260 may activate the sense component 245 (e.g., latch the sense component) and compare the signal received from the memory cell 205 to a reference (e.g., the reference 250). Based on (e.g., in response to) the comparison, the sense component 245 may determine a logic state that is stored on the memory cell 205.

In some cases, a memory device (e.g., including the memory die 200) may assign data with a data type based on one or more parameters associated with the data. For example, the data may be tagged according to a file extension associated with the data, according to a lifetime of the data, or both. Such classification techniques, however, may result in instances of cold data being accessed relatively frequently. In some cases, the frequency which cold data is accessed may be correlated with a frequency of memory management operations performed by the memory device (e.g., garbage collection, fragmentation, or the like), which may incur adverse effects, such as write amplification.

To support data type tagging of data stored to a memory device, the memory device may tag data based on a chunk size of the data. A chunk size of data may be a size of the data, for example, in units of KB, MB, and GB, etc. The memory device may receive a command from a host device to perform an access operation on one or more memory cells 205 of the memory device. The memory device may compare a chunk size of the data to a threshold size in order to determine a data type (e.g., a tag) for the data. For example, if the chunk size is greater than a first threshold size (e.g., 512 KB), the memory device may tag the data chunk as cold data, and if the chunk size is greater than a second threshold size (e.g., 4 KB) but less than the first threshold size, the memory device may tag the data chunk as hot data. By enabling data tagging according to a chunk size of data, the memory device may experience improvements to the performance of access operations.

FIGS. 3A and 3B illustrate examples of a data structure 301 and a data structure 302, respectively, that support techniques for tagging data based on chunk size in accordance with examples as disclosed herein. In some cases, the data structures 301 and 302 may be implemented by one or more aspects of the system 100 and the memory die 200. For example, the data structures 301 and 302 may be examples of tagging (e.g., classification, assignment) techniques for data 305 and data 320, respectively, which may be used by the system 100 or the memory die 200 to support access operations. It should be noted that while the data structures 301 and 302 each depict two data types 315 and 330, respectively, the data structures 301 and 302 may include any quantity of data types 315 and 330. For instance, the data types 315 and 330 may include warm data, a hot, warm, or cold node, hot, warm, and cold meta data, and any combination thereof, among other examples.

In the example of FIG. 3A, the data structure 301 may be an example of the data 305 that is classified according to a file extension 310 of the data 305, a lifetime of the data 305, or both. In some case, the data structure 301 may be an example of data classification performed by a flash memory management system, such as F2FS. The data 305 may be data associated with an access operation to be performed by a memory device (e.g., a memory device 110 as described with reference to FIG. 1). A host device (e.g., a host device 105 as described with reference to FIG. 1) may issue a command to the memory device to store the data 305 in one or more memory cells (e.g., a write operation) or may issue a command for the memory device to sense the data 305 from stored logic states of one or more memory cells (e.g., a read operation). The command may include a first indication of a first data type 315 that is associated with the data 305.

The first data type 315 may be indicated via a tag assigned by the host device (e.g., a flash memory management system). The tag may be assigned according to a file extension 310 associated with the data 305. In some cases, such as when the data 305 has a file extension 310 of .avi, .exe, .gif, .mp4, .wav, .png, .iso, or .pdf, among other examples, the host device may classify the data as cold data. In some cases, such as when the data 305 has a file extension of .db, for example, the host device may classify the data as hot data. Additionally, or alternatively, the tag may be assigned according to a lifetime of the data 305. For example, if the data 305 has been stored to the memory device for a relatively long duration, the host device may classify the data 305 as cold data, and if the data 305 has been stored to the memory device for a relatively short duration, the host device may classify the data as hot data.

In some cases, the data type 315 associated with the data 305 may indicate an access frequency of the data 305. For example, a data type 315 of cold data may indicate that the memory device expects to access the data 305 relatively infrequently. Similarly, a data type 315 of hot data may indicate that the memory device expects to access the data 305 relatively frequently. As such, a memory device may store cold data in one or more memory cells having lower accessibility (e.g., a hard disk). In some cases, tagging data according to a file extension 310 may result in hot data and cold data being stored together, and a memory device may access cold data relatively frequently. Such classification techniques may incur a greater frequency of memory management operations (e.g., garbage collection), correspond to a fragmentation status of the memory device, or both.

In the example of FIG. 3B, the data structure 302 may be an example of the data 320 that is classified according to a data size 325 of the data 320. In some case, the data structure 302 may be an example of data classification performed by a memory device performing an access operation, such as a read operation or a write operation. The data 320 may be data associated with an access operation to be performed by the memory device of a memory system. For example, a host device may issue a command to the memory device to store the data 320 in one or more memory cells (e.g., a write operation) or may issue a command for the memory device to sense the data 320 from stored logic states of one or more memory cells (e.g., a read operation). In some examples, the command may include a first indication of a first data type 330 that is associated with the data 320. The first indication may indicate a tag assigned to the data 320 by the host device (e.g., a flash memory management system) using techniques described with reference to FIG. 3A.

The memory device may determine whether a data size 325 of the data (e.g., X) satisfies one or more threshold sizes based on (e.g., in response to) receiving the access command. For example, the memory device may receive a command to write the data 320 and may identify the data size 325. In some cases, the memory device may compare the data size 325 with a first threshold value, which may represent an update data threshold (e.g., 4 KB or another appropriate data size), and may compare the data size 325 with a second threshold value, which may represent a chunk size threshold (e.g., 512 KB or another appropriate data size).

The memory device may generate a second indication of a second data type 330 for the data 320 based on (e.g., in response to) determining whether the data size 325 satisfies the one or more threshold values. For example, if the memory device determines that the data size 325 satisfies the second threshold value, the memory device may tag the data 320 with a data type 330 of cold data. As another example, if the memory device determines that the data size 325 satisfies the first threshold value and does not satisfy the second threshold value, the memory device may tag the data 320 with a data type 330 of hot data.

In some cases, the memory device may generate the second indication based on the first indication indicating a different data type 330 than determined by the memory device. For instance, if the memory device determines to tag the data 320 as hot data (e.g., based on the data size 325) and identifies the first data type 330 as cold data (e.g., based on the file extension 310), the memory device may generate the second indication of the second data type 330, where the second data type 330 may be hot data. In another example, if the memory device determines to tag the data 320 as cold data and identifies the first data type 330 as hot data, the memory device may generate the second indication of the second data type 330, where the second data type 330 may be cold data. As part of generating the second indication, the memory device may modify a tag for the data 320. For example, the memory device may modify the tag from indicating the first data type 330 to indicating the second data type 330. Such an update may enable the memory device to store the data 320 according to the second data type 330.

FIG. 4 illustrates an example of a process flow 400 that supports techniques for tagging data based on chunk size in accordance with examples as disclosed herein. The process flow 400 may be implemented by one or more aspects of the system 100, the memory die 200, and the data structures 301 and 302 as described with reference to FIGS. 1, 2, 3A, and 3B. For example, the process flow 400 may be an example of operations performed by a host device 405 and a memory device 410, which may be examples of a host device 105 and a memory device 110 described with reference to FIG. 1. Additionally, operations of the memory device 410 may be facilitated by a local memory controller, such as a local memory controller 260 described with reference to FIG. 2. In some cases, the host device 405 and the memory device 410 may perform operations according to the process flow 400 to support tagging data based on a chunk size of the data, as described with reference to FIGS. 3A and 3B. Aspects of the process flow 400 may be implemented by one or more controllers, among other components. Additionally or alternatively, aspects of the process flow 400 may be implemented as instructions stored in one or more memories (e.g., firmware stored in a memory). For example, the instructions, when executed by one or more controllers (e.g., the device memory controller 155), may cause the one or more controllers to perform the operations of the process flow 400. Alternative examples of the following may be implemented, where some processes are performed in a different order than described or are not performed. In some cases, processes may include additional features not mentioned below, or further processes may be added.

At 415, the host device 405 may issue an access command to the memory device 410. The access command may include a write command for the memory device 410 to store information to one or more memory cells or may include a read command for the memory device 410 to sense a stored logic state of one or more memory cells. For example, the host device 405 may indicate that the memory device 410 is to write data to the memory device. Additionally, or alternatively, the access command may include a first indication of a first type of the data associated with the access command. The type of the data may correspond to an access frequency of the data. For example, data accessed relatively frequently may be classified as hot data and data access relatively infrequently may be classified as cold data. In some cases, the memory device 410 may support any quantity of data types, such as hot, warm, or cold data, a hot, warm, or cold node, hot, warm, or cold meta data, or any combination thereof, among other examples.

In some examples, the first data type may be an example of a tag assigned by the host device 405 (e.g., a flash memory management system (e.g., F2FS)) associated with the memory device 410. The host device 405 may tag the data according to a file extension associated with the data. In some cases, such as when the data has a file extension of .avi, .exe, .gif, .mp4, .wav, .png, .iso, or .pdf, among other examples, the host device 405 may classify the data as cold data. In some cases, such as when the data has a file extension of .db, for example, the host device 405 may classify the data as hot data. Additionally, or alternatively, the tag may be assigned according to a lifetime of the data. For example, if the data has been stored to the memory device 410 for a relatively long duration, the host device 405 may classify the data as cold data, and if the data has been stored to the memory device 410 for a relatively short duration, the host device 405 may classify the data as hot data. Such techniques may result in cold data (e.g., less useful data) being accessed relatively frequently (e.g., due to being stored with hot data), which may limit the performance of the memory system.

At 420, the memory device 410 may determine whether a size of the data satisfies one or more threshold. For example, the memory device 410 may determine a chunk size of the data and may compare the chunk size to a first threshold (e.g., an update data threshold) and a second threshold (e.g., a chunk size threshold). In some cases, the memory device 410 may determine that the chunk size satisfies the first threshold. In some cases, the memory device 410 may determine that the chunk size satisfies both the first threshold and the second threshold.

At 425, the memory device 410 may determine a second data type of the data based on (e.g., in response to) determining whether the chunk size satisfies the one or more thresholds. For example, if the memory device 410 determines that the chunk size satisfies the first threshold and does not satisfy the second threshold, the memory device 410 may tag the data with a data type of hot data. As another example, if the memory device 410 determines that the chunk size satisfies the first threshold and satisfies the second threshold, the memory device 410 may tag the data with a data type of cold data. By tagging data according to size, the memory device 410 may improve data storage and retrieval operations (e.g., due to storing data of similar types in similar locations).

At 430, the memory device 410 may generate a second indication of the second type of the data. In some cases, the memory device 410 may generate the second indication based on the first indication and determining whether the data satisfies the one or more thresholds. For example, if the first indication indicates the first data type as hot data and the memory device 410 determines the second data type as cold data, the memory device 410 may generate an indication of the second type of the data. As another example, if the first indication indicates the first data type as cold data and the memory device 410 determines the second data type as hot data, the memory device 410 may generate an indication of the second type of the data. In some cases, the first indication, the second indication, or both may include a tag for the data indicating the associated data type. As part of generating the second indication, the memory device 410 may modify the tag for the data from indicating the first type of the data to the second type of the data.

At 435, the memory device 410 may select a data type as part of generating the second indication at 430. For example, the memory device 410 may select the second data type from a set of types of data, where the set of types of data may include the first data type, the second data type, a third data type, a fourth data type, a fifth data type, a sixth data type, or a combination thereof. Such data types may correspond to hot, warm, or cold data, a hot, warm, or cold node, and hot, warm, or cold meta data, among other examples.

At 440, the memory device 410 may write the data to a buffer of the memory device 410 based on (e.g., in response to) generating the second indication. For example, the memory device 410 may store the data to a set of multiple first blocks for storing the data in a first type of memory cells. In some cases, the first blocks may support the first type of memory cells having various storage densities. For example, the first type of memory cells may be single-level cells (SLCs) configured to store one bit of information. In a second example, the first type of memory cells may be triple-level cells (TLCs) configured to store three bits of information. In a third example, the first type of memory cells may be quad-level cells (QLCs) configured to store four bits of information. The memory device 410 may support any quantity of memory cell architectures, and is not limited to any of the above examples.

At 445, the memory device 410 may flush one or more buffers of information stored to the memory device 410. In some cases, a flushing operation may involve transferring information stored to memory cells of a first storage density (e.g., SLCs) to memory cells of a second storage density (e.g., TLCs, QLCs, or the like). Tagging data according to a size of the data may increase performance of the memory device 410 by reducing a quantity of write operations that include data which may be less useful (e.g., cold data).

At 450, the memory device 410 may perform a memory management operation, such as garbage collection. In some cases, the performance of the memory management operation may be improved by tagging the data based on a size of the data. For example, a garbage collection operation may involve erasing a memory block of the memory device 410 to allow for subsequent write operations on the memory block. By tagging data based on size, the garbage collection may perform a reduced quantity of write operations, which may be associated with accessing different data types.

FIG. 5 illustrates a block diagram 500 of a memory device 520 that supports techniques for tagging data based on chunk size in accordance with examples as disclosed herein. The memory device 520 may be an example of aspects of a memory device as described with reference to FIGS. 1 through 4. The memory device 520, or various components thereof, may be an example of means for performing various aspects of techniques for tagging data based on chunk size as described herein. For example, the memory device 520 may include a command reception component 525, a data size identification component 530, an indication generation component 535, a data writing component 540, a data type determination component 545, a data type selection component 550, a data chunk size determination component 555, a data tag modification component 560, or any combination thereof. Each of these components may communicate, directly or indirectly, with one another (e.g., via one or more buses).

The command reception component 525 may be configured as or otherwise support a means for receiving a command to write data to the memory device 520, the command including a first indication of a first type of the data. The data size identification component 530 may be configured as or otherwise support a means for determining whether a size of the data satisfies a threshold based at least in part on the command. The indication generation component 535 may be configured as or otherwise support a means for generating a second indication of a second type of the data based at least in part on whether the size of the data satisfies the threshold. The data writing component 540 may be configured as or otherwise support a means for writing the data to a buffer including a first plurality of blocks for storing the data in a first type of memory cells based at least in part on the second indication of the second type of the data.

In some examples, the data type determination component 545 may be configured as or otherwise support a means for determining whether the first type of the data corresponds to cold data based at least in part on whether the size of the data satisfies the threshold, where generating the second indication of the second type of the data is based at least in part on whether the first type of the data corresponds to cold data, the second type of the data including hot data.

In some examples, the data type determination component 545 may be configured as or otherwise support a means for determining whether the first type of the data corresponds to hot data based at least in part on whether the size of the data satisfies the threshold, where generating the second indication of the second type of the data is based at least in part on whether the first type of the data corresponds to hot data, the second type of the data including cold data.

In some examples, the data type selection component 550 may be configured as or otherwise support a means for selecting the second type of the data from a set of types of data, the set of types of data including the first type of the data, the second type of the data, a third type of the data, a fourth type of the data, a fifth type of the data, or a sixth type of the data, or a combination thereof, where generating the second indication of the second type of the data is based at least in part on the second type of the data from the set of types of data.

In some examples, the data chunk size determination component 555 may be configured as or otherwise support a means for determining a chunk size of the data, where determining whether the size of the data satisfies the threshold is based at least in part on the chunk size of the data.

In some examples, the first indication includes an extension associated with the data.

In some examples, the first plurality of blocks includes a plurality of single-level cell memory blocks. In some examples, the first type of memory cells includes single-level memory cells.

In some examples, to support writing the data, the data writing component 540 may be configured as or otherwise support a means for writing the data to the plurality of single-level cell memory blocks for storing the data in the single-level memory cells.

In some examples, the first plurality of blocks includes a plurality of triple-level cell memory blocks. In some examples, the first type of memory cells includes triple-level memory cells.

In some examples, to support writing the data, the data writing component 540 may be configured as or otherwise support a means for writing the data to the plurality of triple-level cell memory blocks for storing the data in the triple-level memory cells.

In some examples, the first plurality of blocks includes a plurality of quad-level cell memory blocks. In some examples, the first type of memory cells includes quad-level memory cells.

In some examples, to support writing the data, the data writing component 540 may be configured as or otherwise support a means for writing the data to the plurality of quad-level cell memory blocks for storing the data in the quad-level memory cells.

In some examples, the first indication, the second indication, or both, includes a tag indicating the first type of the data, the second type of the data, or both.

In some examples, to support generating the second indication, the data tag modification component 560 may be configured as or otherwise support a means for modifying the tag for the data from indicating the first type of the data to the second type of the data.

In some examples, the memory device 520 includes an F2FS.

FIG. 6 illustrates a flowchart showing a method 600 that supports techniques for tagging data based on chunk size in accordance with examples as disclosed herein. The operations of method 600 may be implemented by a memory device or its components as described herein. For example, the operations of method 600 may be performed by a memory device as described with reference to FIGS. 1 through 5. In some examples, a memory device may execute a set of instructions to control the functional elements of the device to perform the described functions. Additionally, or alternatively, the memory device may perform aspects of the described functions using special-purpose hardware.

At 605, the method may include receiving a command to write data to a memory device, the command including a first indication of a first type of the data. The operations of 605 may be performed in accordance with examples as disclosed herein. In some examples, aspects of the operations of 605 may be performed by a command reception component 525 as described with reference to FIG. 5.

At 610, the method may include determining whether a size of the data satisfies a threshold based at least in part on the command. The operations of 610 may be performed in accordance with examples as disclosed herein. In some examples, aspects of the operations of 610 may be performed by a data size identification component 530 as described with reference to FIG. 5.

At 615, the method may include generating a second indication of a second type of the data based at least in part on whether the size of the data satisfies the threshold. The operations of 615 may be performed in accordance with examples as disclosed herein. In some examples, aspects of the operations of 615 may be performed by an indication generation component 535 as described with reference to FIG. 5.

At 620, the method may include writing the data to a buffer including a first plurality of blocks for storing the data in a first type of memory cells based at least in part on the second indication of the second type of the data. The operations of 620 may be performed in accordance with examples as disclosed herein. In some examples, aspects of the operations of 620 may be performed by a data writing component 540 as described with reference to FIG. 5.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving a command to write data to a memory device, the command including a first indication of a first type of the data; determining whether a size of the data satisfies a threshold based at least in part on the command; generating a second indication of a second type of the data based at least in part on whether the size of the data satisfies the threshold; and writing the data to a buffer including a first plurality of blocks for storing the data in a first type of memory cells based at least in part on the second indication of the second type of the data.

Aspect 2: The method, apparatus, or non-transitory computer-readable medium of aspect 1, further including operations, features, circuitry, logic, means, or instructions, or any combination thereof for determining whether the first type of the data corresponds to cold data based at least in part on whether the size of the data satisfies the threshold, where generating the second indication of the second type of the data is based at least in part on whether the first type of the data corresponds to cold data, the second type of the data including hot data.

Aspect 3: The method, apparatus, or non-transitory computer-readable medium of any of aspects 1 through 2, further including operations, features, circuitry, logic, means, or instructions, or any combination thereof for determining whether the first type of the data corresponds to hot data based at least in part on whether the size of the data satisfies the threshold, where generating the second indication of the second type of the data is based at least in part on whether the first type of the data corresponds to hot data, the second type of the data including cold data.

Aspect 4: The method, apparatus, or non-transitory computer-readable medium of any of aspects 1 through 3, further including operations, features, circuitry, logic, means, or instructions, or any combination thereof for selecting the second type of the data from a set of types of data, the set of types of data including the first type of the data, the second type of the data, a third type of the data, a fourth type of the data, a fifth type of the data, or a sixth type of the data, or a combination thereof, where generating the second indication of the second type of the data is based at least in part on the second type of the data from the set of types of data.

Aspect 5: The method, apparatus, or non-transitory computer-readable medium of any of aspects 1 through 4, further including operations, features, circuitry, logic, means, or instructions, or any combination thereof for determining a chunk size of the data, where determining whether the size of the data satisfies the threshold is based at least in part on the chunk size of the data.

Aspect 6: The method, apparatus, or non-transitory computer-readable medium of any of aspects 1 through 5, where the first indication includes an extension associated with the data.

Aspect 7: The method, apparatus, or non-transitory computer-readable medium of any of aspects 1 through 6, where the first plurality of blocks includes a plurality of single-level cell memory blocks and the first type of memory cells includes single-level memory cells.

Aspect 8: The method, apparatus, or non-transitory computer-readable medium of aspect 7, where writing the data includes operations, features, circuitry, logic, means, or instructions, or any combination thereof for writing the data to the plurality of single-level cell memory blocks for storing the data in the single-level memory cells.

Aspect 9: The method, apparatus, or non-transitory computer-readable medium of any of aspects 1 through 10, where the first plurality of blocks includes a plurality of triple-level cell memory blocks and the first type of memory cells includes triple-level memory cells.

Aspect 11: The method, apparatus, or non-transitory computer-readable medium of aspect 9, where writing the data includes operations, features, circuitry, logic, means, or instructions, or any combination thereof for writing the data to the plurality of triple-level cell memory blocks for storing the data in the triple-level memory cells.

Aspect 12: The method, apparatus, or non-transitory computer-readable medium of any of aspects 1 through 11, where the first plurality of blocks includes a plurality of quad-level cell memory blocks and the first type of memory cells includes quad-level memory cells.

Aspect 14: The method, apparatus, or non-transitory computer-readable medium of aspect 12, where writing the data includes operations, features, circuitry, logic, means, or instructions, or any combination thereof for writing the data to the plurality of quad-level cell memory blocks for storing the data in the quad-level memory cells.

Aspect 15: The method, apparatus, or non-transitory computer-readable medium of any of aspects 1 through 14, where the first indication, the second indication, or both, includes a tag indicating the first type of the data, the second type of the data, or both.

Aspect 16: The method, apparatus, or non-transitory computer-readable medium of aspect 15, where generating the second indication includes operations, features, circuitry, logic, means, or instructions, or any combination thereof for modifying the tag for the data from indicating the first type of the data to the second type of the data.

Aspect 17: The method, apparatus, or non-transitory computer-readable medium of any of aspects 1 through 16, where the memory device includes a F2FS.

It should be noted that the methods described herein describe possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorous, boron, or arsenic. Doping may be performed during the initial formation or growth of the substrate, by ion-implantation, or by any other doping means.

A switching component (e.g., a transistor) discussed herein may represent a field-effect transistor (FET), and may comprise a three-terminal component including a source (e.g., a source terminal), a drain (e.g., a drain terminal), and a gate (e.g., a gate terminal). The terminals may be connected to other electronic components through conductive materials (e.g., metals, alloys). The source and drain may be conductive, and may comprise a doped (e.g., heavily-doped, degenerate) semiconductor region. The source and drain may be separated by a doped (e.g., lightly-doped) semiconductor region or channel. If the channel is n-type (e.g., majority carriers are electrons), then the FET may be referred to as a n-type FET. If the channel is p-type (e.g., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” when a voltage greater than or equal to the transistor's threshold voltage is applied to the transistor gate. The transistor may be “off” or “deactivated” when a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

The functions described herein may be implemented in hardware, software executed by a processor, firmware, or any combination thereof. If implemented in software executed by a processor, the functions may be stored on or transmitted over as one or more instructions (e.g., code) on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

For example, the various illustrative blocks and modules described in connection with the disclosure herein may be implemented or performed with a processor, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or any type of processor. A processor may also be implemented as a combination of computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a computer, or a processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. An apparatus, comprising:
a memory device comprising memory cells; and
one or more controllers coupled with the memory device and configured to cause the apparatus to:
receive a command to write data to the memory device, the command comprising a first indication of a first type of the data;
determine whether a size of the data satisfies a threshold based at least in part on the command;
generate a second indication of a second type of the data based at least in part on whether the size of the data satisfies the threshold; and
write the data to a buffer comprising a first plurality of blocks for storing the data in a first type of memory cells based at least in part on the second indication of the second type of the data.

2. The apparatus of claim 1, wherein the one or more controllers are further configured to cause the apparatus to:
determine whether the first type of the data corresponds to cold data based at least in part on whether the size of the data satisfies the threshold,
wherein to generate the second indication of the second type of the data is based at least in part on whether the first type of the data corresponds to cold data, the second type of the data comprising hot data.

3. The apparatus of claim 1, wherein the one or more controllers are further configured to cause the apparatus to:
determine whether the first type of the data corresponds to hot data based at least in part on whether the size of the data satisfies the threshold,
wherein to generate the second indication of the second type of the data is based at least in part on whether the first type of the data corresponds to hot data, the second type of the data comprising cold data.

4. The apparatus of claim 1, wherein the one or more controllers are further configured to cause the apparatus to:
select the second type of the data from a set of types of data, the set of types of data comprising the first type of the data, the second type of the data, a third type of the data, a fourth type of the data, a fifth type of the data, or a sixth type of the data, or a combination thereof, wherein generating the second indication of the second type of the data is based at least in part on the second type of the data from the set of types of data.

5. The apparatus of claim 1, wherein the one or more controllers are further configured to cause the apparatus to:
determine a chunk size of the data,
wherein to determine whether the size of the data satisfies the threshold is based at least in part on the chunk size of the data.

6. The apparatus of claim 1, wherein the first indication comprises an extension associated with the data.

7. The apparatus of claim 1, wherein:
the first plurality of blocks comprises a plurality of single-level cell memory blocks, and
the first type of memory cells comprises single-level memory cells.

8. The apparatus of claim 7, wherein, to write the data, the one or more controllers are configured to cause the apparatus to:
write the data to the plurality of single-level cell memory blocks for storing the data in the single-level memory cells.

9. The apparatus of claim 1, wherein:
the first plurality of blocks comprises a plurality of triple-level cell memory blocks, and
the first type of memory cells comprises triple-level memory cells.

10. The apparatus of claim 9, wherein, to write the data, the one or more controllers are configured to cause the apparatus to:
write the data to the plurality of triple-level cell memory blocks for storing the data in the triple-level memory cells.

11. The apparatus of claim 1, wherein:
the first plurality of blocks comprises a plurality of quad-level cell memory blocks, and
the first type of memory cells comprises quad-level memory cells.

12. The apparatus of claim 11, wherein, to write the data, the one or more controllers are configured to cause the apparatus to:
write the data to the plurality of quad-level cell memory blocks for storing the data in the quad-level memory cells.

13. The apparatus of claim 1, wherein the first indication, the second indication, or both, comprises a tag indicating the first type of the data, the second type of the data, or both.

14. The apparatus of claim 13, wherein, to generate the second indication, the one or more controllers are configured to cause the apparatus to:
modify the tag for the data from indicating the first type of the data to the second type of the data.

15. The apparatus of claim 1, wherein the memory device comprises a flash-friendly file system (F2FS).

16. A non-transitory computer-readable medium storing code comprising instructions which, when executed by a processor of an electronic device, cause the electronic device to:
receive a command to write data to a memory device, the command comprising a first indication of a first type of the data;
determine whether a size of the data satisfies a threshold based at least in part on the command;
generate a second indication of a second type of the data based at least in part on whether the size of the data satisfies the threshold; and
write the data to a buffer comprising a first plurality of blocks for storing the data in a first type of memory cells based at least in part on the second indication of the second type of the data.

17. The non-transitory computer-readable medium of claim 16, wherein the instructions, when executed by the processor of the electronic device, further cause the electronic device to:
determine whether the first type of the data corresponds to cold data based at least in part on whether the size of the data satisfies the threshold,
wherein to generate the second indication of the second type of the data is based at least in part on whether the first type of the data corresponds to cold data, the second type of the data comprising hot data.

18. The non-transitory computer-readable medium of claim 16, wherein the instructions, when executed by the processor of the electronic device, further cause the electronic device to:
determine whether the first type of the data corresponds to hot data based at least in part on whether the size of the data satisfies the threshold,
wherein to generate the second indication of the second type of the data is based at least in part on determining whether the first type of the data corresponds to hot data, wherein the second type of the data comprises cold data.

19. The non-transitory computer-readable medium of claim 16, wherein the instructions, when executed by the processor of the electronic device, further cause the electronic device to:
select the second type of the data from a set of types of data, the set of types of data comprising the first type of the data, the second type of the data, a third type of the data, a fourth type of the data, a fifth type of the data, or a sixth type of the data, or a combination thereof,
wherein to generate the second indication of the second type of the data is based at least in part on selecting the second type of the data from the set of types of data.

20. A method, comprising:
receiving a command to write data to a memory device, the command comprising a first indication of a first type of the data;
determining whether a size of the data satisfies a threshold based at least in part on the command;
generating a second indication of a second type of the data based at least in part on whether the size of the data satisfies the threshold; and
writing the data to a buffer comprising a first plurality of blocks for storing the data in a first type of memory cells based at least in part on the second indication of the second type of the data.
